(19) United States
(12) Patent Application Publication
(10) Pub. No.: US 2022/0342644 A1
(43) Pub. Date: Oct. 27, 2022

(54) BRANCHING AND MERGING IN A DESIGN INTERFACE

(71) Applicant: Figma, Inc., San Francisco, CA (US)

(72) Inventors: John Fuetsch, San Francisco, CA (US); Kiko Lam, San Francisco, CA (US); Shana Hu, San Francisco, CA (US); Matthew Owen, San Francisco, CA (US); Stephanie Cheuk, San Francisco, CA (US); Meagan Gamache, San Francisco, CA (US); Amanda Yeh, San Francisco, CA (US)

(21) Appl. No.: 17/726,251

(22) Filed: Apr. 21, 2022

Related U.S. Application Data
(60) Provisional application No. 63/177,728, filed on Apr. 21, 2021.

(51) Int. Cl. G06F 8/34; G06F 8/71

(52) U.S. Cl. CPC G06F 8/34; G06F 8/71

(57) ABSTRACT

A network computer provides interactive graphic design system instructions for execution at a user computing device. The user computing device receives main workspace data describing a main design interface, renders the main design interface, and provides an input interface for the user. The user computing device interprets a branch input action by the user to create a branch from the main design interface, obtains branch workspace data for a branch design interface generated based on the main workspace data, interprets one or more change input actions to the branch design interface, and updates the branch workspace data. The user computing device obtains a set of differences between the branch design interface and the main design interface identified based on the main workspace data and the branch workspace data, and renders a review interface. The review interface includes a visual representation of at least one difference.

### CROSS-REFERENCE TO RELATD APPLICATIONS

This application claims the benefit of U.S. Provisional Patent Application No. 63/177,728, filed Apr. 21, 2021; the aforementioned priority application being hereby incorporated by reference in its entirety for all purposes.

### TECHNICAL FIELD

Examples described herein relate to a network computer system, and relate more specifically to version control in interactive graphic design systems.

### BACKGROUND

Software design tools have many forms and applications. In the realm of application user interfaces, for example, software design tools require designers to blend functional aspects of a program with aesthetics and even legal requirements, resulting in a collection of pages that form the user interface of an application. For a given application, designers often have many objectives and requirements that are difficult to track.

### BRIEF DESCRIPTION OF THE DRAWINGS

FIG. 1A illustrates an interactive graphic design system for a computing device of a user, according to one or more examples.

FIG. 1B illustrates a network computing system to implement an interactive graphic design system on a user computing device, according to one or more examples.

FIG. 1C illustrates a network computing system to implement an interactive graphic design system for multiple users in a collaborative network platform, according to one or more examples.

FIGS. 2A-2F illustrate review interfaces and/or visual representations of differences between a branch design interface and a main design interface, according to one or more examples.

FIG. 3 illustrates a timeline comprising checkpoints for a main design interface and a branch design interface, in accordance with one or more examples.

FIGS. 4A-4B illustrate processes for branching and merging in a design interface, according to one or more examples.

FIG. 5 illustrates a computer system on which one or more embodiments can be implemented.

FIG. 6 illustrates a user computing device for use with one or more examples, as described.

### DETAILED DESCRIPTION

Examples include a computer system that can operate to implement an interactive graphic design system that enables users to perform branching and merging in a design interface. In examples, a computer system is configured to implement an interactive graphic design system for designers, such as user interface designers (“UI designers”), web designers, and web developers. Among other advantages, examples as described enable such users to create a branch design interface from a main design interface. The main design interface and the branch design interface may be accessed and/or modified independently of each other, and may have separate data, files, addresses, version histories, access permissions for their own sets of users, and other separate properties. The examples further enable such users to review the design changes and merge the branch design interface with the main design interface. After a merge operation, the resulting design interface may replace the main design interface. Examples may be deployed in a collaborative environment, and may streamline the management of large design systems.

According to some examples, a computing device operates to receive interactive graphic design system instructions and main workspace data describing a main design interface. The computing device renders the main design interface for display to a user at the user computing device and provides an input interface for the user. The computing device interprets a branch input action by the user to create a branch design interface from the main design interface. In response to the branch input action, the computing device obtains branch workspace data for the branch design interface that is generated based on the main workspace data. The computing device interprets one or more change input actions by the user to the branch design interface. In response to the one or more change input actions, the computing device updates the branch workspace data. The computing device obtains a set of differences between the branch design interface and the main design interface that are identified based on the main workspace data and the branch workspace data, and renders a review interface for display to the user. The review interface includes a visual representation of the least one difference between the branch design interface and the main design interface. In examples, the computing device merges the main design interface and the branch design interface by updating the main workspace data based on one or more review input actions by the user in response to the review interface.

Still further, in some examples, a network computer system includes memory resources storing a set of instructions, and one or more processors operable to communicate the set of instructions to a plurality of user devices. The set of instructions can be communicated to user computing devices and executed at the user computing devices to render a branch design interface on a canvas. The branch design interface can be edited by user input that is indicative of any one of multiple different input actions. The set of instructions can be executed on the computing devices to cause each of the computing devices to determine one or more input actions to perform based on user input. The instructions may further cause the user computing devices to modify the design interface based on one or more input actions.

In some examples, for at least a first computing device, the instructions can be executed to cause the computing device to: receive main workspace data describing a main design interface, and render the main design interface for display to a user at the user computing device, and render a review interface for display to the user. The computing device interprets a branch input action by the user to create a branch from the main design interface. In response to the branch input action, the computing device generates branch workspace data for a branch design interface based on the main workspace data. The computing device interprets one or more change input actions by the user to the branch design interface. In response to the one or more change input actions, the computing device updates the branch workspace data. The computing device may provide change data to update the network computer system regarding changes to the branch workspace data. The computing device may display a review interface that includes a visual representation of the least one difference between the branch design interface and the main design interface. In examples, the computing device merges the main design interface and the branch design interface by updating the main workspace data based on one or more review input actions by the user in response to the review interface.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices and/or tablets), and magnetic memory. Computers, terminals, network-enabled devices (e.g., mobile devices, such as cell phones) are all examples of machines and devices that utilize processors, memory, and instructions stored on computer-readable mediums. Additionally, embodiments may be implemented in the form of computer-programs, or a computer-usable carrier medium capable of carrying such a program.

### System Description

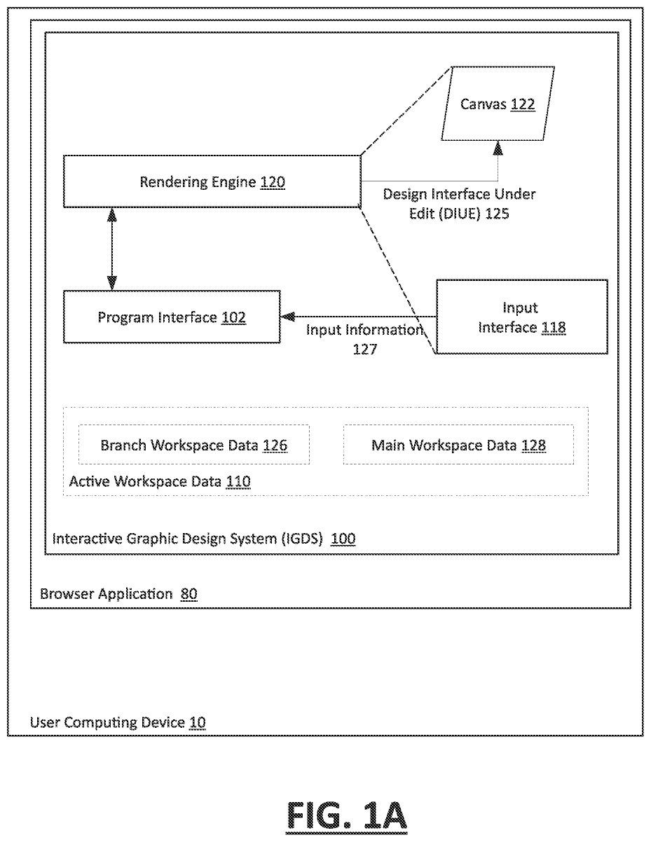

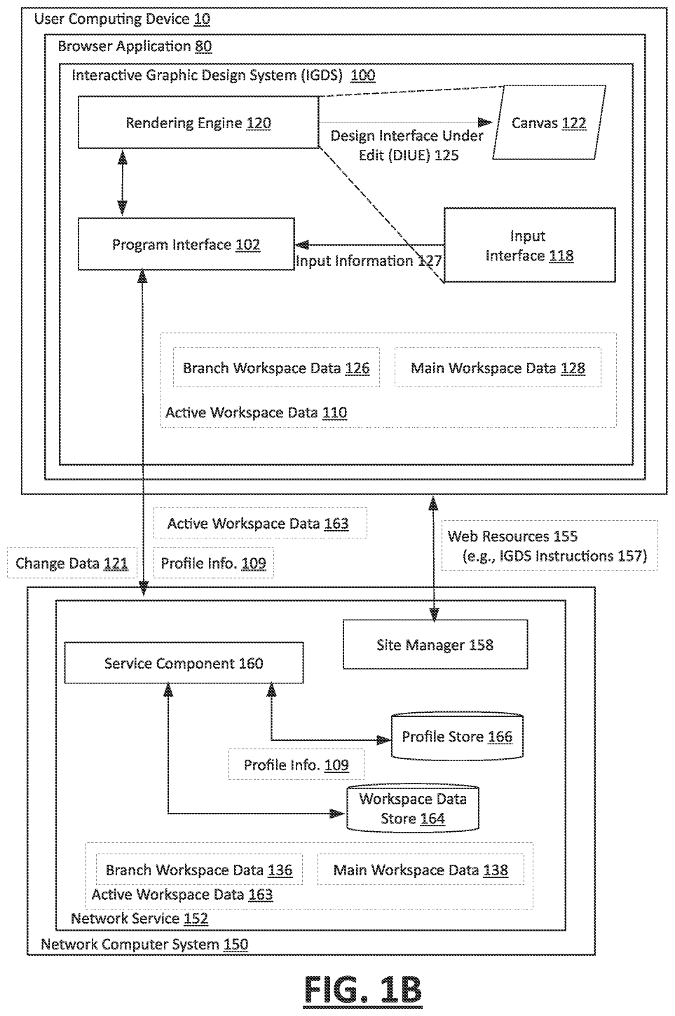

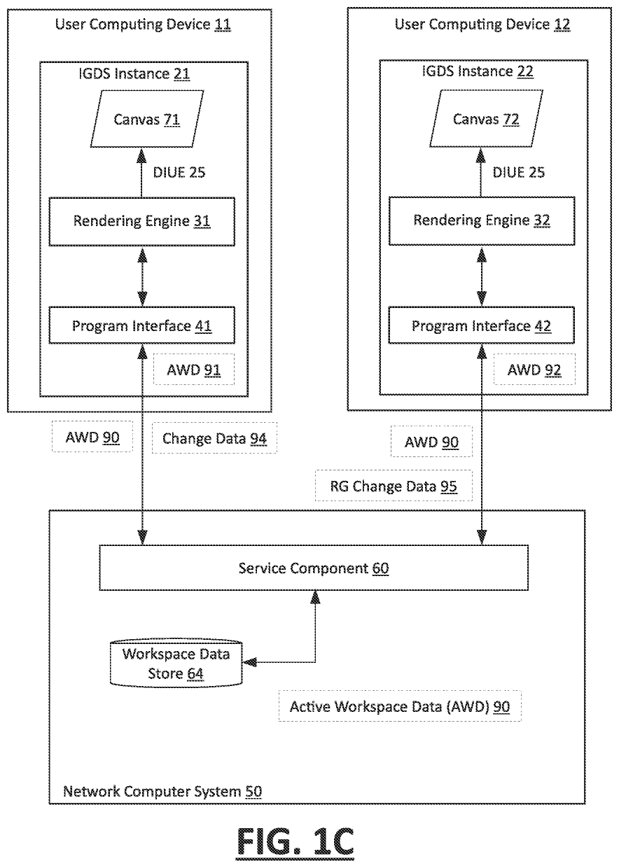

FIG. 1A illustrates an interactive graphic design system for a computing device of a user, according to one or more examples. An interactive graphic design system (IGDS) 100 can be implemented in any one of multiple different computing environments. For example, in some variations, the IGDS 100 can be implemented as a user-side application that executes on the user computing device 10 to provide functionality as described with various examples. For example, as described below, the IGDS 100 can be implemented as a web application that executes in a browser application 80. As an addition or alternative, the IGDS 100 may be implemented as a native application developed for use on a particular platform, such as but not limited to LINUX, ANDROID, WINDOWS, or another platform. As an addition or alternative, the IGDS 100 can be implemented as a distributed system, such that processes described with various examples execute on a network computer (e.g., server) and on the user device 10.

According to examples, the IGDS 100 can be implemented on a user computing device 10 to enable a corresponding user to create, view, and/or modify various types of design interfaces using graphical elements. A design interface may include any layout of content and/or interactive elements, such as but not limited to a web page. The IGDS 100 can include processes that execute as or through a browser application 80 that is installed on the computing device 10.

As used herein, the term “browser application” refers to any program that accesses web content over a network, such as by using the Hypertext Transfer Protocol (HTTP) to access information resources over the Internet. In some examples, the browser application 80 is a commercially available browser application, such as but not limited to GOOGLE CHROME (developed by GOOGLE, INC.), SAFARI (developed by APPLE, INC.), and EDGE/INTERNET EXPLORER (developed by the MICROSOFT CORPORATION). As described by various examples, a browser application 80 can execute scripts, code, and/or other logic (the “programmatic components”) to implement the functionality of the IGDS 100. Additionally, in some variations, the IGDS 100 can be implemented as part of a network service, where a browser application 80 communicates with one or more remote computers (e.g., server used for a network service) to execute processes of the IGDS 100.

In some examples, a browser application 80 retrieves some or all of the programmatic resources for implementing the IGDS 100 from a network site. As an addition or alternative, a browser application 80 can retrieve some or all of the programmatic resources from a local source (e.g., local memory residing with the computing device 10). The browser application 80 may also access various types of data sets in providing the IGDS 100. The data sets can correspond to files and libraries, which can be stored remotely (e.g., on a server, in association with an account) or locally.

In examples, the IGDS 100 is implemented as web code that executes in a browser application 80. In such examples, the processes of the IGDS 100 can be implemented as web code, such as HyperText Markup Language (HTML), JAVASCRIPT, Cascading Style Sheets (CSS), other scripts, and/or other embedded code which the browser application 80 downloads from a network site. For example, the browser application 80 can execute web code that is embedded within a web page, causing the IGDS 100 to execute at the user computer device 10 in the browser application 80. The web code can also cause the browser application 80 to execute and/or retrieve other scripts and programmatic resources (e.g., libraries) from the network site and/or other local or remote locations. By way of example, the browser application 80 may include JAVASCRIPT embedded in an HTML resource (e.g., web page structured in accordance with HTML 5.0 or other versions, as provided under standards published by W3C or WHATWG consortiums) that is executed by the browser application 80. In some examples, the rendering engine 120 and/or other components may utilize graphics processing unit (GPU) accelerated logic, such as provided through WebGL (Web Graphics Library) programs which execute Graphics Library Shader Language (GLSL) programs that execute on GPUs.

According to examples, a user of the computing device 10 operates the browser application 80 to access a network site, where programmatic resources are retrieved and executed to implement the IGDS 100. In this way, the user may initiate a session to implement the IGDS 100 to create, view, and/or modify a design interface. In some examples, the IGDS 100 includes a program interface 102, an input interface 118, and a rendering engine 120. The program interface 102 can include one or more processes that execute to access and retrieve programmatic resources from local and/or remote sources.

In some implementations, the program interface 102 can generate a canvas 122 using programmatic resources that are associated with the browser application 80 (e.g., an HTML 5.0 canvas). As an addition or variation, the program interface 102 can trigger or otherwise cause the canvas 122 to be generated using programmatic resources and data sets (e.g., canvas parameters) which are retrieved from local (e.g., memory) or remote sources (e.g., from network service).

The program interface 102 may also retrieve programmatic resources that include an application framework for use with the canvas 122. The application framework can include data sets that define or configure a set of interactive graphic tools that integrate with the canvas 122. For example, the interactive graphic tools include an input interface 118, to enable the user to provide input for creating and/or editing a design interface.

According to some examples, the input interface 118 can be implemented as a functional layer that is integrated with the canvas 122 to detect and interpret user input, such as the input interface 118. The input interface 118 is a user interface that can, for example, use a reference of the canvas 122 to identify a screen location of a user input (e.g., ‘click’). Additionally, the input interface 118 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In this manner, the input interface 118 can interpret, for example, a series of inputs as a design tool selection (e.g., shape selection based on location/s of input), as well as inputs to define properties (e.g., dimensions) of a selected shape.

Additionally, the program interface 102 can be used to retrieve, from local or remote sources, programmatic resources and data sets that include active workspace data 110. As used herein, the term “workspace data” refers to data describing a design interface that can be loaded by the IGDS 100, the term “design interface under edit” refers to a design interface that is loaded in the IGDS 100, and the term “active workspace data” refers to workspace data describing a design interface under edit (DIUE) that is loaded in the IGDS 100.

The retrieved data sets can include one or more pages that include design elements that collectively form a design interface, or a design interface that is in progress. For example, the program interface 102 may be used to retrieve one or more files comprising active workspace data 110 that include one or multiple data structure representations which collectively define the DIUE 125. For example, the active workspace data may include main workspace data 128 that describes a main design interface. When the main design interface is selected as the DIUE 125, the program interface 102 may retrieve the main workspace data 128.

The IGDS 100 may also load and/or request additional data sets that are associated with the active workspace. As an example, the program interface 102 can retrieve, from local memory, or another source (e.g., from network service 152 of FIG. 1B), one or more types of profile information (e.g., profile information 109 of FIG. 1B), such as user profile information that identifies past activities of the user of the computing device 10 when utilizing the IGDS 100. The profile information can identify, for example, input types (or actions) of the user with respect to the page(s) of the active workspace, or more generally, input actions of the user in a prior time interval. In some variations, the profile information can also identify historical or contextual information about individual design interfaces associated with the profile.

In some examples, the rendering engine 120 renders the DIUE 125 described by the active workspace data 110 on the canvas 122. For example, when the main design interface is selected as the DIUE 125, the rendering engine 120 renders the main design interface described by the main workspace data 128. The DIUE 125 includes graphic elements and their respective properties as described by the active workspace data 110. The user can edit the DIUE 125 using the input interface 118. As an addition or alternative, the rendering engine 120 can generate a blank page for the canvas 122, and the user can use the input interface 118 to generate the DIUE 125. As rendered, the DIUE 125 can include graphic elements such as a background and/or a set of objects (e.g., shapes, text, images, programmatic elements), as well as properties of the individual graphic elements. Each property of a graphic element can include a property type and a property value. For an object, the types of properties include shape, dimension (or size), layer, type, color, line thickness, font color, font family, font size, font style, and/or other visual characteristics. Depending on implementation details, the properties reflect attributes of two- or three-dimensional designs. In this way, property values of individual objects can define visual characteristics such as size, color, positioning, layering, and content for elements that are rendered as part of the DIUE 125. Workspace data, such as the active workspace data 110 corresponding to the DIUE 125, can describe one or more objects belonging to the design interface.

In examples, individual design elements may also be defined in accordance with a desired run-time behavior. By way of example, some objects can be defined to have run-time behaviors that are either static or dynamic. The properties of dynamic objects may change in response to predefined run-time events generated by the underlying application that is to incorporate the DIUE 125. Additionally, some objects may be associated with logic that defines the object as being a trigger for rendering or changing other objects, such as through implementation of a sequence or workflow. Still further, other objects may be associated with logic that provides the design elements to be conditional as to when they are rendered and/or their respective configuration or appearance when rendered. Still further, objects may also be defined to be interactive, where one or more properties of the object may change based on user input during the run-time of the application.

The input interface 118 can process at least some user inputs to determine input information 127, where the input information 127 indicates (i) an input action type (e.g., shape selection, object selection, sizing input, color selection), (ii) an object or objects that are affected by the input action (e.g., an object being resized), (iii) a desired property that is to be altered by the input action, and/or (iv) a desired value for the property being altered. The program interface 102 can receive the input information 127, and the program interface 102 can implement changes indicated by the input information 127 to update the active workspace data 110. The rendering engine 120 can update the canvas 122 to reflect the changes to the affected objects in the DIUE 125. For example, when the main design interface is selected as the DIUE 125, the program interface 102 updates the main workspace data 128, and the rendering engine 120 updates the canvas 122 to reflect changes to the main design interface indicated by the input information 127.

### Branching

A user may create a branch design interface from the main design interface, also referred to as branching. For example, a user may wish to create a branch design interface to edit a version of the main design interface. The branch design interface may be safely edited without affecting the main design interface, such as to implement a proposed design change. The branch design interface may be modified in isolation from the main design interface, which may undergo other edits in a separate environment.

In examples, a user may use the input interface 118 to initiate a branching operation. For example, the input interface 118 may provide a menu or other interface to select a branch input action with respect to a main design interface. The program interface 102 interprets the branch input action to create a branch from the main design interface. In response to the branch input action, the IGDS 100 obtains branch workspace data 126 for a branch design interface. The branch workspace data 126 is generated based on the main workspace data 128. For example, the branch workspace data 126 may initially be a separate copy of the main workspace data 128 accessible by its own filename, path, Uniform Resource Locator (URL), or other address data. The branch design interface is available for the user to edit in the IGDS 100.

The IGDS 100 may obtain the branch workspace data 126 by generating the branch workspace data 126 at the user computing device 10 based on the main workspace data 128. As an alternative or addition, the IGDS 100 may obtain the branch workspace data 126 from a network computer system (e.g., network computer system 150, 50) that generates the branch workspace data 136 from the main workspace data 138 at the network computer system. For example, the IGDS 100 may request the branch workspace data 136 from the service component 160 of the network computer system 150 and maintain a user-side copy of the branch workspace data 126.

The branching operation occurs at a point in time referred to as the branch point. A branch point may also refer to the last common version or checkpoint before the branch design interface was created from the main design interface. After the branching operation, both the main design interface and the branch design interface are available for edit to users with permissions to edit the respective design interface. When the branch design interface is selected as the DIUE 125 in the IGDS 100, the rendering engine 120 renders the branch design interface described by the branch workspace data 126, and the input interface 118 processes at least some user inputs to determine input information 127 corresponding to changes indicated by the input information 127 to update the branch workspace data 126. The branch workspace data 126 and the main workspace data 128 may be accessed and/or modified independently of each other. For example, the branch workspace data 126 and the main workspace data 128 may have separate data, files, addresses, version histories, access permissions for their own sets of users, and other separate properties.

### Network Computing System to Implement IGDS

FIG. 1B illustrates a network computer system to implement an interactive graphic design system on a user computing device, according to one or more examples. A network computer system 150 can be implemented using one or more servers that communicate with user computing devices over one or more networks. In some examples, the network computer system 150 performs operations to enable the interactive graphic design system (IGDS) 100 to be implemented on the user computing device 10.

In variations, the network computer system 150 provides a network service 152 to support the use of the IGDS 100 by one or more user computing devices 10, including user computing devices 10 that utilize a browser application 80. The network computer system 150 can include a site manager 158 that manages a website where a set of web resources 155 (e.g., web pages, web code, and/or other web resources) are made available for site visitors. The web resources 155 can include instructions, such as scripts or other logic, which are executable by browsers or web components of user computing devices. In some variations, once the browser application 80 accesses and downloads the web resources 155, the browser application 80 executes the IGDS instructions 157 to implement functionality such as described with some examples of FIG. 1A. For example, the IGDS instructions 157 can be executed by browser application 80 to initiate the program interface 102 on the user computing device 10. The initiation of the program interface 102 may coincide with the establishment of, for example, a web-socket connection between the program interface 102 and a service component 160 of the network computer system 150.

In some examples, the IGDS instructions 157, when executed in the browser application 80, initiate one or more processes of the program interface 102, causing the IGDS 100 to retrieve additional programmatic resources and data sets for implementing functionality as described herein by one or more examples. The web resources 155 can, for example, embed logic (e.g., JAVASCRIPT code), including GPU accelerated logic, in an HTML page for download by computing devices of users. The program interface 102 can be triggered to retrieve additional programmatic resources and data sets from, for example, the network service 152, and/or from local resources of the computing device 10. For example, some of the components of the IGDS 100 can be implemented through web pages that can be downloaded onto the user computing device 10 after authentication is performed, and/or once the user performs additional actions (e.g., downloading one or more pages of the workspace associated with the account identifier). Accordingly, in one or more examples as described, the network computer system 150 can communicate the IGDS instructions 157 to the user computing device 10 through a combination of network communications, where the IGDS instructions 157 are received and executed by the browser application 80.

Upon accessing the website, browser application 80 can automatically (e.g., through saved credentials) or through manual input, communicate an account identifier to the service component 160. In some examples, browser application 80 can also communicate one or more additional identifiers that correlate to a user identifier. Additionally, in some examples, the service component 160 can use the user or account identifier of the user identifier to retrieve profile information 109 from a user profile store 166. As an addition or variation, profile information 109 for the user can be determined and stored locally on the user computing device 10. The service component 160 may also determine, based on the user credentials, a permission setting or role of the user in connection with the account identifier. The permission settings or role of the user can determine, for example, workspace data that can be accessed by the user. In some examples, the implementation of the rendering engine 120 on the user computing device 10 can be configured based at least in part on the role or setting of the user and/or affiliation of the user with a particular organization.

The service component 160 can also retrieve and provide workspace data describing a workspace that is linked to the user account or identifier from a workspace data store 164. For example, when a user selects a particular design interface to load in the IGDS 100, the program interface 102 may submit a request to the service component 160. The service component 160 may access the workspace data store 164 to retrieve the corresponding active workspace data 163 and provide the active workspace data 163 to the IGDS 100.

The workspace data 163 may include main workspace data 138 corresponding to a main design interface and/or branch workspace data 136 corresponding to a branch design interface created in a branching operation on a particular main design interface. When a user selects a main design interface, the program interface 102 may submit a request to the service component 160, which retrieves the main workspace data 138 from the workspace data store 164 and provides the main workspace data 138 to the IGDS 100. The IGDS 100 may maintain a user-side copy of the received main workspace data 138 (e.g., main workspace data 128). When a user selects a branch design interface, the program interface 102 may submit a request to the service component 160, which retrieves the branch workspace data 136 from the workspace data store 164 and provides the branch workspace data 136 to the IGDS 100. The IGDS 100 may maintain a user-side copy of the received branch workspace data 136 (e.g., branch workspace data 126).

During a branching operation, the user computing device 10 may initially create user-side branch workspace data 126 based on user-side main workspace data 128, and provide the user-side branch workspace data 126 to the network computer system 150 so that the network computer system 150 can work with, store, update, and serve the branch workspace data 136. As an alternative or addition, the program interface 102 may send a request to the service component 160 so that the service component 160 generates branch workspace data 136 from main workspace data 138 at the network computer system 150. The service component 160 may provide the generated branch workspace data 136 to the program interface 102 in response to the request. The IGDS 100 may maintain a user-side copy of the received branch workspace data 136 (e.g., branch workspace data 126). The network computer system 150 may store the branch workspace data 136 in the workspace data store 164 and make the branch workspace data 136 available to other users.

In some examples, the input interface 118 includes a file browser that allows users with the proper permissions to access design interfaces, including a branch design interface and/or a corresponding main design interface. The access control for specified users to view, edit, or perform other operations on a branch design interface may be the same or different than access control for the corresponding main design interface. In some examples, a branch design interface may be private, and its presence may be hidden in the file browser from users without the corresponding permissions.

In some examples, the IGDS 100 maintains user-side active workspace data 110 corresponding to the active workspace data 163 received from the network computer system 150, such as the branch workspace data 126 and/or the main workspace data 128. For example, the user-side active workspace data 110 may begin as a copy of the received active workspace data 163 that is stored in memory at the user computing device 10. In some examples, the IGDS 100 initiates a canvas 122 and renders the corresponding design interface under edit (DIUE) 125 to the canvas 122 based on the active workspace data 110. For example, the IGDS 100 can initiate an HTML 5.0 canvas as a component of the browser application 80, and the rendering engine 120 can render the corresponding DIUE 125 on the canvas 122.

In some examples, any changes to the DIUE 125 made using the IGDS 100 can also be updated in the user-side active workspace data 110, as stored on the computing device 10. For example, when the main design interface is the DIUE 125, the main workspace data 128 is updated, and when the branch design interface is the DIUE 125, the branch workspace data 126 is updated. In some embodiments, the program interface 120 sends change data 121 to the network computer system 150. The change data 121 reflects one or more changes to the DIUE 125 made in the IGDS 100 and to the user-side active workspace data 110. For example, the program interface 102 can stream change data 121 to the service component 160 periodically and/or in real-time as changes are made at the user computing device 10.

At the network computer system 150, the service component 160 can receive the change data 121, which in turn can be used to implement changes to the server-side active workspace data 163. In this way, the server-side active workspace data 163 at the network computer system 150 can mirror (or be synchronized with) the user-side active workspace data 110 on the user computing device 10. For example, the program interface 102 can stream the changes as change data 121 to the service component 160 in order to synchronize the user-side active workspace data 110 and the server-side active workspace data 163 corresponding to the DIUE 125. This process can be performed repeatedly or continuously so that the user-side active workspace data 110 and the server-side active workspace data 163 describing the DIUE 125 remain synchronized.

### Collaborative Network Platform

FIG. 1C illustrates a network computer system to implement an interactive graphic design system for multiple users in a collaborative network platform, according to one or more examples. In an example of FIG. 1C, a collaborative network platform is implemented by the network computer system 50, which communicates with multiple user computing devices 11-12 over one or more networks (e.g., the World Wide Web) to implement interactive graphic design system (IGDS) instances 21-22 on the user computing devices 11-12. While FIG. 1C illustrates an example in which two users utilize the collaborative network platform, examples as described allow for the network computer system 50 to enable collaboration on design interfaces among users using a larger number of user computing devices. Among other advantages, the collaborative network platform allows users to more concurrently access a design interface, and to conveniently manipulate objects based on a shared property value while the network computer system 50 manages synchronization and access issues.

With respect to FIG. 1C, the user computing devices 11-12 can be assumed as being operated by users that are associated with a common account or accounts associated with the same design interface. Each user computing device 11-12 implements an IGDS instance 21-22 to access the same design interface (e.g., design interface under edit (DIUE) 25) during respective sessions that overlap with one another. Accordingly, each of the user computing devices 11-12 may access the same set of active workspace data 90 at the same time, with the respective program interface 41-42 of the IGDS instance 21-22 operating to establish a corresponding communication channel (e.g., a web socket connection) with the service component 60. In examples, the service component 60 can load the active workspace data 90 corresponding to the DIUE 25 from a workspace data store 64, and transmit a copy of the active workspace data 90 to each user computing device 11-12 such that the respective rendering engines 31-32 render the DIUE 25 corresponding to the active workspace data 90 at the same time, such as during overlapping sessions.

In some examples, after receiving the active workspace data 90, the IDGS instance 21 maintains user-side active workspace data 91 at user computing device 11, and the IDGS instance 22 maintains user-side active workspace data 92 at user computing device 12. The service component 60 can also maintain network-side active workspace data 90 for the DIUE 25 loaded by the IGDS instances 21-22.

In some examples, the network computer system 50 can continuously synchronize the active workspace data 90-92 corresponding to the DIUE 25 loaded in one or more IGDS instances 21-22 on the user computing devices 11-12. In particular, changes made by users to the DIUE 25 on one user computing device 11 may be reflected on the DIUE 25 rendered on the other user computing device 12 in real-time. By way of example, when a change is made to the DIUE 25 at user computing device 11, the respective rendering engine 31 updates the respective canvas 71, and the respective program interface 41 updates the respective user-side active workspace data 91. The respective program interface 41 of the IGDS instance 21 transmits change data 94 reflecting the DIUE 25 change to the service component 60. The service component 60 processes the change data 94 from the user computing device 11 and uses the change data 94 to make a corresponding change to the server-side active workspace data 90. The service component 60 can also transmit remotely-generated change data 95 (which in the example provided, corresponds or reflects the change data 94 received from the user computing device 11) to the other user computing device 12 that has loaded the same DIUE 25, causing the corresponding IGDS instance 22 to update the DIUE 25, such as by causing the program interface 42 to update the corresponding user-side active workspace data 92 and causing the respective rendering engine 32 to update the respective canvas 72. In this manner, active workspace data 91-92, including branch workspace data 126 and the corresponding main workspace data 128, are synchronized across any user computing devices 11-12 that are using the respective workspace data.

To facilitate the synchronization of the active workspace data 90-92 at the user computing devices 11-12 and the network computer system 50, the network computer system 50 may implement a stream connector to merge data streams between the network computer system 50 and user computing devices 11-12 that have loaded the same DIUE 25 (e.g., the branch design interface and/or the main design interface). For example, the stream connector may merge a first data stream between user computing device 11 and the network computer system 50 with a second data stream between user computing device 12 and the network computer system 50. In some implementations, the stream connector can be implemented to enable each computing device 11-12 to make changes to the server-side active workspace data 90 without added data replication that may otherwise be required to process the streams from each user computing device 11-12 separately.

Additionally, over time, one or more user-side active workspace data 91-92 versions may become out-of-sync with the server-side active workspace data 90. In such cases, the respective computing device 11-12 can re-download some or all of the server-side active workspace data 90 to restart its maintenance of the corresponding user-side active workspace data 91-92 and DIUE 25 rendered on the respective canvas 71-72.

### EXAMPLES

### Set of Differences

After a branching operation, the branch workspace data 126, 136 and the main workspace data 128, 138 may be accessed and/or modified independently of each other. For example, the branch workspace data 126, 136 and the main workspace data 128, 138 may have separate data, files, addresses, version histories, access permissions for their own sets of users, and other separate properties. Change input actions made in the IGDS 100 to the branch design interface by one or more users are reflected in the branch workspace data 126, 136. One or more change input actions may also be made in the IGDS 100 to the main design interface while the branch design interface is active, which are reflected in the main workspace data 128, 138.

The IGDS 100 is configured to obtain a set of differences between the branch design interface and the main design interface. For example, the IGDS 100 may obtain the set of differences by identifying the set of differences at the user computing device 10 based on user-side main workspace data 128 and user-side branch workspace data 126 at the user computing device 10. As an alternative or addition, the IGDS 100 may obtain the set of differences over a network, such as by sending a request over the Internet to a network computer system (e.g. network computer system 150, 50) that supports the interactive graphic design system (IGDS) 100 at one or more user computing devices. In this case, the network computer system generates the set of differences based on main workspace data 138 and branch workspace data 136 that is maintained by the network computer system.

The branch workspace data may include data describing a current version of the branch design interface and one or more historical versions of the branch design interface. The main workspace data may include data describing a current version of the main design interface and one or more historical versions of the main design interface. When the IGDS 100 obtains the set of differences between the branch design interface and the main design interface, the differences may be identified between a current or any historical version of the branch design interface and/or the main design interface. For example, the set of differences may be determined between a current version of the branch design interface (also referred to as the branch tip) and the main design interface at the branch point. As an alternative or addition, the set of differences may be determined between a current version of the main design interface (also referred to as the main tip) and the branch design interface at the branch point.

In some examples, a design interface is represented as a graph that includes a set of nodes arranged in graph or other hierarchical structure. Workspace data for a design interface may include data describing the set of nodes along with data describing the hierarchical structure. The set of differences between the branch design interface and the main design interface may include changes within a particular node, the addition of a particular node (e.g., in the branch workspace data 126, 136), the removal of a particular node (e.g., from the main workspace data 128, 138), and/or the movement of a particular node in the hierarchical structure. A particular node that includes a difference may affect child nodes and/or parent nodes. The differences are described in greater detail hereinafter.

The set of differences may be used to allow the user to perform operations, such as visually rendering the differences between the branch design interface and the main design interface for review, updating the branch design interface with changes to the main design interface, and merging the branch design interface with the main design interface.

### EXAMPLES

### Visualization of Differences

The IGDS 100 is also configured to render a review interface for display to the user. The review interface includes a visual representation of at least one difference between the branch design interface and the main design interface. A visual representation may include a rendering of a component or other portion of the design interface, a thumbnail rendering, an abstract representation (e.g., a color swatch, typeface), or another visual representation. The set of differences obtained between the branch design interface and the main design interface may include visual display metadata describing how the IGDS should render one or more differences.

The IGDS may present the review interface when a user initiates an operation. For example, a user may initiate a review operation, such as by selecting an option to review differences between the main design interface and the branch design interface. In some examples, a user may request another user to review the design changes to the branch design interface, and the review interface is presented to the other user. As an addition or alternative, the IGDS may present the review interface during a merge operation to merge the branch design interface and the main design interface. Merge operations are described in greater detail hereinafter.

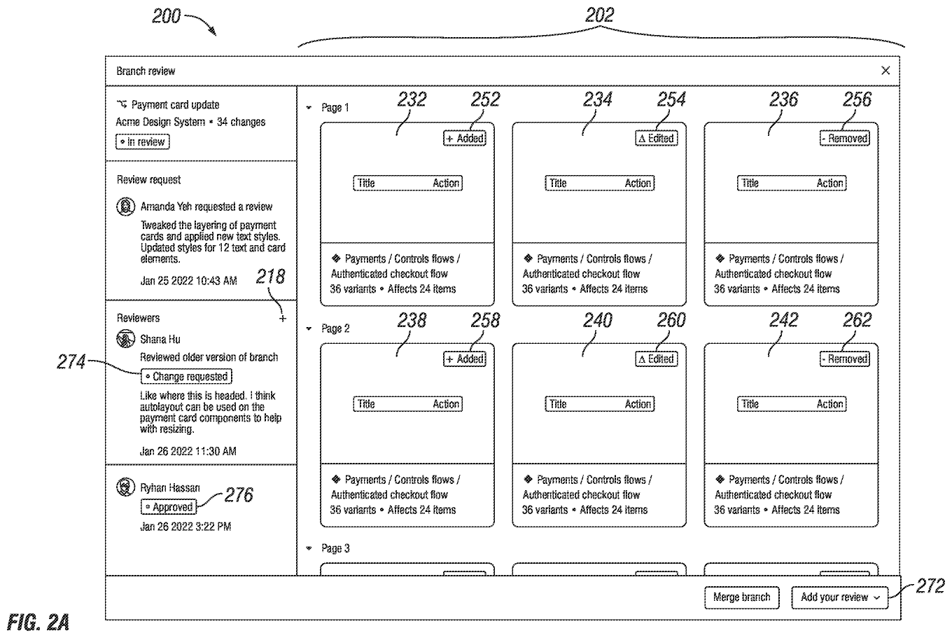

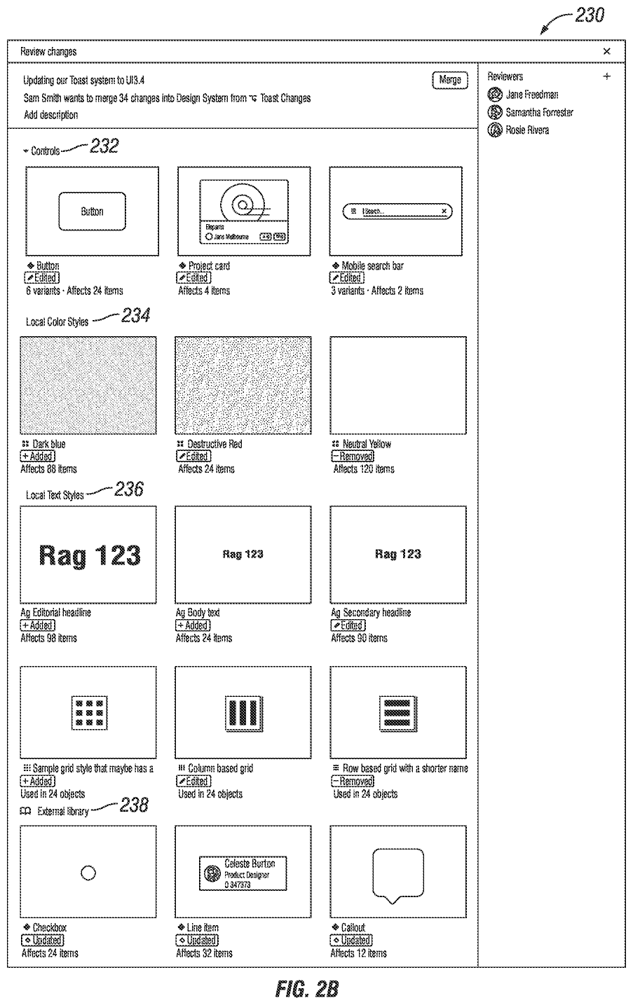

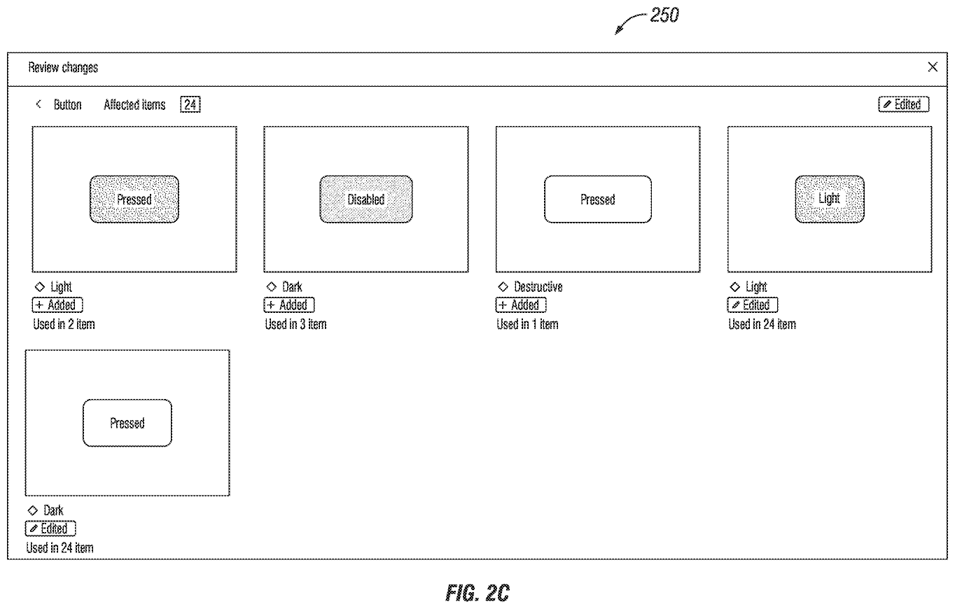

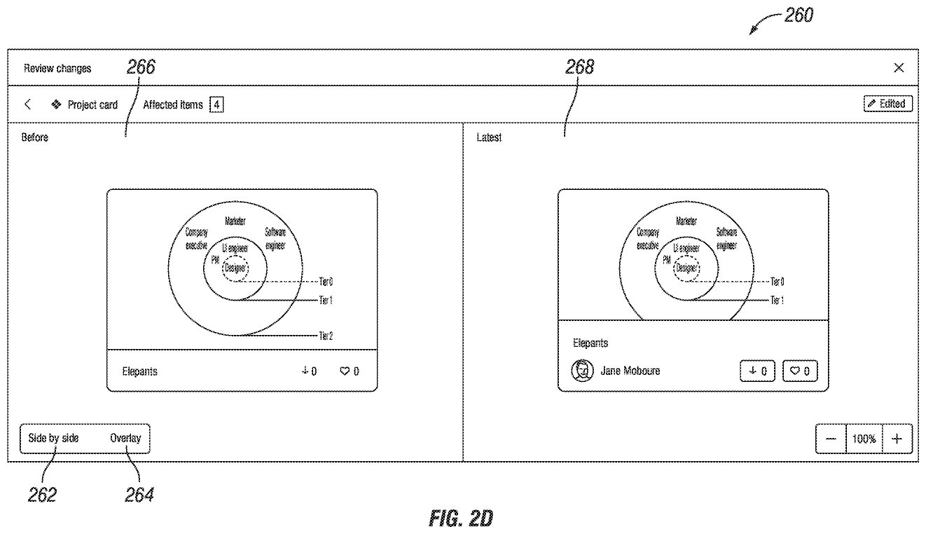

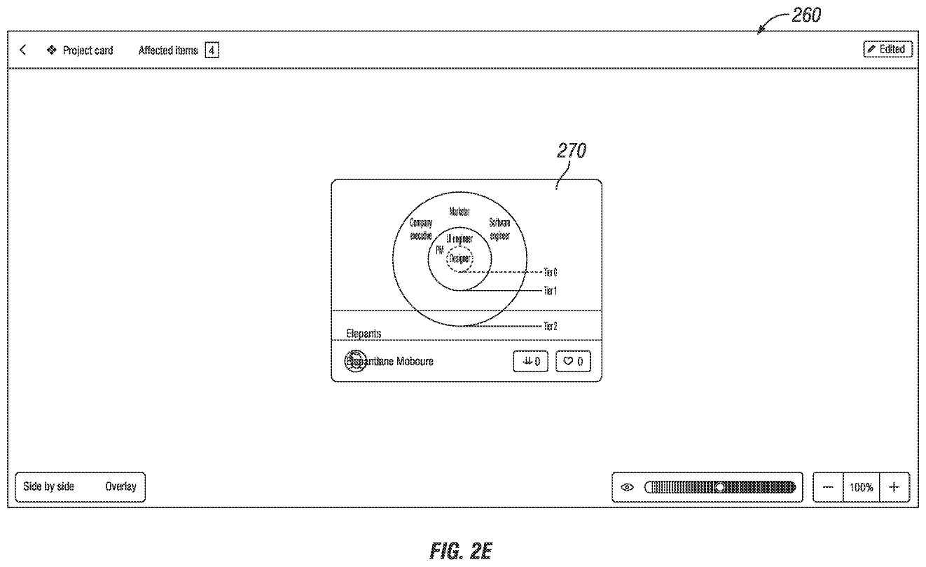

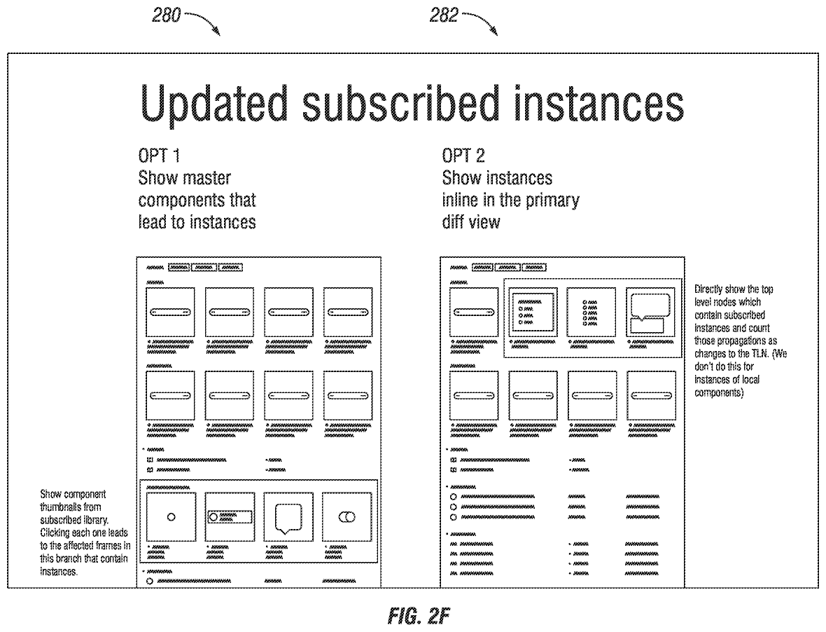

Example review interfaces are presented in FIGS. 2A-2F showing non-limiting examples of visual representations of differences between a branch design interface and a main design interface. FIG. 2A illustrates a review interface comprising a visual representation of a set of differences identified between a branch design interface and a main design interface, according to one or more examples. The example review interface 200 is a top-level view comprising a summary of a set of differences 202 identified between a branch design interface and a main design interface. The review interface 200 includes a visual representation 232-242 of one or more differences as they appear in the branch design interface. In some examples, additional review interfaces describing a particular change in greater detail can be accessed, such as by selecting a particular difference presented in review interface 200. In examples, the review interface 200 may include a status indicator for one or more differences presented in the review interface 200. For example, a status indicator 252-262 may indicate that a particular difference corresponds to an element that is added to the branch design interface (e.g., status indicators 252 and 258), an element present in the main design interface that is edited in the branch design interface (e.g., status indicators 254 and 260), and/or an element present in the main design interface that is removed from the branch design interface (e.g., status indicators 256 and 262).

The review interface 200 may include a set of style changes 202. For a particular style difference, a visual representation 232-242 may show an example of a different style in the branch design interface, such as a new color property. The visual representation 232-242 may also display a visual example of one or more other property differences for the new style, such as but not limited to a color, style, shape, size, dimension, position, or font. The review interface 200 may further indicate the objects that are affected as a result of the changed style. In some examples, downstream effects of a change to a style may be rendered. For example, when the user selects an option to view the downstream effects, the user may be presented with a second review interface that includes thumbnails of one or more frames that are affected by the style change. As an addition or alternative, the review interface 200 may include a set of one or more component changes. For each component change, a visual representation 232-242 may show an example of the changes to the component in the branch design interface.

As an addition or alternative, the review interface 200 may include one or more differences that do not include a visual representation. Such differences may include a text description of the difference between the main design interface and the branch design interface. Some other examples of differences that may be described without a visual representation include movement of a component to a different page, the changing of a component name or description, the removal of a component, the addition or removal of a library, the changing of constraints associated with a component, the detaching of a style from a component without changing the properties associated with the style, and the like.

The review interface 200 may include an indicator that conflicts are present between the branch design interface and the main design interface. A conflict may arise when changes have been made to the same object and/or property in the branch design interface and the main design interface after the branch point. A conflict may also arise if a change has been made in one design interface, and the corresponding object has been deleted in the other design interface. For example, a conflict may be detected when the same node has been modified in both the main design interface and the branch design interface. As an alternative or addition, a conflict may be detected when the same chunk has been modified. Chunks are described in greater detail hereinafter. The review interface 200 may require that the conflicts are resolved before additional operations are taken, such as a merge operation or an update-from-main operation, which are described in greater detail hereinafter.

In some examples, a user can launch a review operation at any time to generate the review interface 200 to review the current state of differences between the main design interface and the branch design interface. As an addition or alternative, the review interface 200 may include collaborative features to request a review from another user, such as one or more colleagues with the appropriate permissions to view the branch design interface. For example, the review interface 200 may include a feature 272 to allow a reviewing user to initiate a review. As an addition or alternative, the review interface 200 may include a feature 218 to allow a user to add one or more users as reviewers in a collaborative review.

In some examples, a network computer system 150 may allow additional edits on the main design interface and/or the branch design interface during a review operation. For example, the review interface 200 may indicate when additional changes have been made to the main design interface and/or the branch design interface after a review operation has started. For example, The review interface 200 may prompt a reviewing user to reload the review to identify and display the latest differences between the main design interface and the branch design interface.

In some examples, the review interface 200 allows a reviewing user to suggest changes to a feature in the branch design interface. The review interface 200 may allow the reviewing user to input a request for a change that describes one or more suggested changes in the branch design interface. The design interface 200 may enable text-based suggestion input. A suggestion that is input by a reviewing user may be associated with one or more corresponding features.

In examples, when a suggestion is input by a reviewing user, one or more notifications are sent to one or more other users, such as a designer user, one or more other reviewing users, one or more requesting users that requested a review, or other users. In examples, a designer user may review the suggestion, make additional changes to the branch design interface based on the suggestion, and request further review. As an alternative or addition, the designer user may review the suggestion, respond to the suggestion without making additional changes to the branch design interface, and request further review. Further review may be implemented as a continuation of the current review or a new review.

In some examples, the review interface 200 displays a review status 274-276 for one or more reviewing users. For example, review status 274 indicates that a first user has requested a change regarding one or more of the set of differences 202, while review status 276 indicates that a second user has approved the set of differences 202.

FIG. 2B illustrates a review interface comprising a visual representation of a set of differences identified between a branch design interface and a main design interface, according to one or more examples. The example review interface 230 is another example top-level view comprising a summary of the set of differences along with a visual representation of one or more differences as they appear in the branch design interface. The review interface 230 includes a set of control changes 232, a set of local color style changes 234, a set of local text style changes 236.

A visual representation of a difference may include a further indicator, such as “Edited”, “Added”, and “Removed”. “Edited” indicates that the visualized difference is an edit to an existing feature in either the branch design interface or the main design interface. “Added” indicates that the visualized change is a new feature. “Removed” indicates that the visualized change is a feature that was removed.

The review interface 230 includes a set of external library changes 238. A design interface may refer to an external library. For example, one or more components or other features may be defined in library that is imported for use in a design interface. An external library may be added or removed in a branch design interface. An external library may also be changed itself. The indicator “Updated” indicates that an external library was changed, and the change affects one or more components or other features in the design interface.

FIG. 2C illustrates a review interface comprising a visual representation of a set of differences identified for a variant set of variant components, according to one or more examples. A variant set includes a set of multiple components, where each component represents a state or version of an interactive design feature. For example, a component may be a button, and the variant set may include multiple variant components each comprising the button in a different state (e.g. pressed, disabled). The review interface 250 shows three new variant components that were added in a branch design interface and two new variant components that were edited in the branch design interface.

FIG. 2D illustrates a review interface comprising a side-by-side rendering of a portion of a branch design interface and a main design interface, according to one or more examples. Review interface 260 provides a detail view regarding a particular difference between the branch tip (such as a current version of the branch design interface) and the branch point (such as the last common checkpoint between the branch design interface and the main design interface). In some examples, a detail-view review interface 260 is presented when a particular difference is selected in another interface, such as the top-level review interface 200, 230. In some examples, a detail view of a particular difference may be rendered for one or more conflicts after a user initiates a conflict resolution process, such as by selecting an option presented in the conflict indicator 214 of the top-level review interface 200.

In some examples, the detail-view review interface 260 includes a side-by-side option 262 and an overlay option 264. In the side-by-side option 262, the visual representation includes a first rendering of a portion of the main design interface 266 and a second rendering of the corresponding portion of the branch design interface 268. For example, the portion of the main design interface 266 and the corresponding portion of the branch design interface 268 may be a rendering of a node and/or a chunk in the branch design interface and the main design interface (or in the branch point).

FIG. 2E illustrates a review interface comprising an overlay rendering of a portion of a branch design interface and a main design interface, according to one or more examples. In the overlay option 264, the visual representation includes a single overlay rendering 270 of the relevant portion of the branch design interface highlighting the change made to the main design interface (or a single rendering of the relevant portion of the main design interface marked up to show the change in the branch design interface). For example, the overlay may use transparency to show the differences in the relevant portion of the design interface.

FIG. 2F illustrates review interfaces comprising multiple instances affected by a design change. Some changes to a branch interface can affect multiple components. For example, a change to a style or a library may affect multiple instances. Furthermore, when a design interface includes hierarchical objects and/or nodes, a change may potentially affect child objects and/or nodes. Review interface 280 includes master components that lead to instances that are affected by a change. Review interface 282 is another example for showing instances that are affected by a change in an inline manner.

### EXAMPLES

### Chunk (Related Differences)

A chunk of related differences, or chunk, is a logical grouping of one or more related differences. For example, if the set of differences between a branch design interface and a main design interface includes an edited color property and an edited font property for a particular button component, a chunk may include both differences for the particular button component. The IGDS (e.g., IGDS 100) may render a review interface that includes a visual representation of the chunk of related differences.

In some examples, one or more chunks are determined based on a hierarchical structure of the workspace data. For example, differences identified in a particular node may be potentially logically grouped into a chunk. As another example, a chunk may include differences identified in a node and one or more of its child nodes. In this case, the parent node is the display node, and the changes in the display node and one or more child nodes are rendered as a single visual representation of the chunk of related differences. By grouping related differences identified within a subgraph of the hierarchical structure, the visual representation of the related differences in the chunk may provide the user adequate context to understand the change.

### EXAMPLES

### Merge Operation

A branching operation creates a fork in the version history of a main design interface. A merge operation integrates changes in the branch design interface into the main design interface. After the merge operation, the main workspace data (e.g., main workspace data 128, 138) is updated to include changes in the branch design interface since the branch point. The changes are identified based on the main workspace data and the branch workspace data (e.g., branch workspace data 126, 136). A merge operation may include the identification of the set of differences and the presentation of the review interface described above with respect to FIGS. 2A-2F. In some examples, the IGDS (e.g., IGDS 100) renders a review interface that summarizes the results of a merge operation before committing the merge operation.

The merge operation is performed by updating the main workspace data based on the set of differences and optionally one or more review input actions by the user in response to one or more review interfaces. In some examples, the main workspace data is updated by the interactive graphic design system (IGDS) at a user computing device (e.g., user computing device 10-12). As an alternative or addition, the main workspace data may be updated by a network computer system (e.g., network computer system 150, 50). In examples, the merge operation appears in the version history of the main design interface as a single event. For example, the version history for the main design interface may include a snapshot prior to the merge operation and a snapshot after the merge operation with all changes applied. The version history may include a final snapshot for the branch design interface.

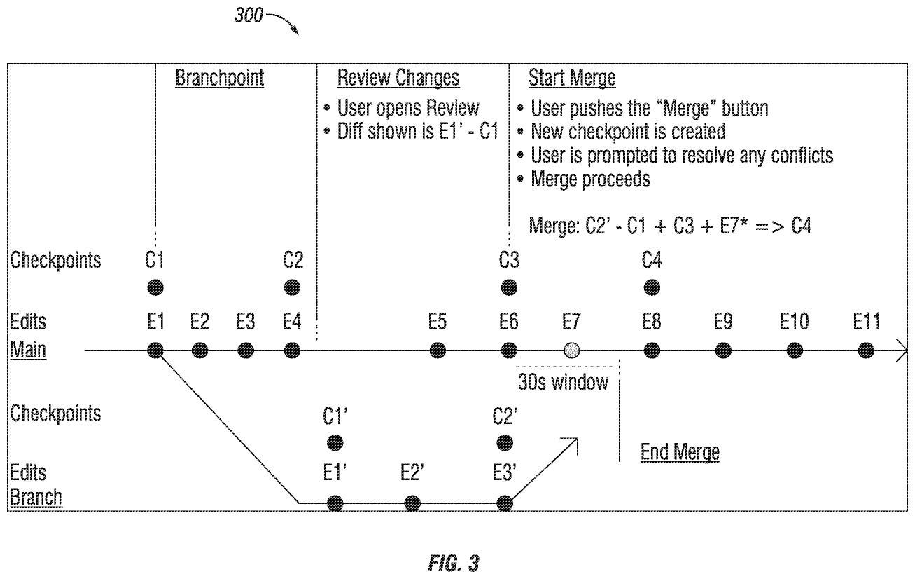

FIG. 3 illustrates a timeline comprising checkpoints for a main design interface and a branch design interface, in accordance with one or more examples. A checkpoint is a snapshot of workspace data for a design interface at a point in time. The snapshot may be a complete snapshot or a portion of workspace data from which the state of the design interface at the point int time can be generated (e.g., in conjunction with earlier data). Checkpoints may be periodically taken for each design interface. Separate checkpoints are taken for the main design interface and the branch design interface when the branch design interface is active. Checkpoints C1-C4 are taken for the main design interface, and checkpoints C1 and C2′ are taken for the branch design interface. Intermediate checkpoints may exist between the checkpoints shown on the timeline 300.

In some examples, a user must have edit permissions on the main design interface to perform a merge operation. The merge operation may be performed after a review operation. When the merge operation is initiated, a checkpoint C3 is created for the main design interface. If another user edits the main design interface after checkpoint C3, the edits must be handled. In the example shown in timeline 300, edit E7 is made after the merge operation is initiated, and the edit E7 is handled by dropping the edit E7. The main workspace data is updated by applying the approved changes, taking into account any conflict resolution inputs from the user described with respect to FIGS. 2A-2F. The checkpoint C4 corresponds to the merged main design interface. In some examples, after a successful merge operation, the branch design interface and corresponding branch workspace data may be archived or otherwise made inactive.

### EXAMPLES

### Update-From -Main Operation

An update-from-main operation integrates changes in the main design interface since the branch point into the branch design interface. After the update-from-main operation, the branch workspace data (e.g., branch workspace data 126, 136) is updated to include changes made on the main design interface since the branch point. As an alternative or addition, the branch workspace data may be updated to include changes made to the main design interface since another synchronization operation, such as a prior update-from-main operation occurring after the branch point. The changes are identified based on the branch workspace data and the main workspace data (e.g., main workspace data 128, 138).

An update-from-main operation may be carried out in a similar manner as a merge operation. For example, an update-from-main operation may include similar techniques performed for a merge operation, such as but not limited to identifying a set of differences between the branch design interface and the main design interface, presenting of one or more review interface such as those described above with respect to FIGS. 2A-2F, and conflict resolution techniques described herein. In some examples, the IGDS (e.g., IGDS 100) renders a review interface that summarizes the results of an update-from-main operation before committing the update-from-main operation.

The merge operation is performed by updating the branch workspace data based on the set of differences and optionally one or more review input actions by the user in response to one or more review interfaces. In some examples, the branch workspace data is updated by the interactive graphic design system (IGDS) at a user computing device (e.g., user computing device 10-12). As an alternative or addition, the branch workspace data may be updated by a network computer system (e.g., network computer system 150, 50). In examples, the update-from-main operation appears in the version history of the branch design interface as a single event. For example, the version history of the branch design interface may include a snapshot prior to the update-from-main operation and a snapshot after the update-from-main operation with all changes applied.

### Methodology

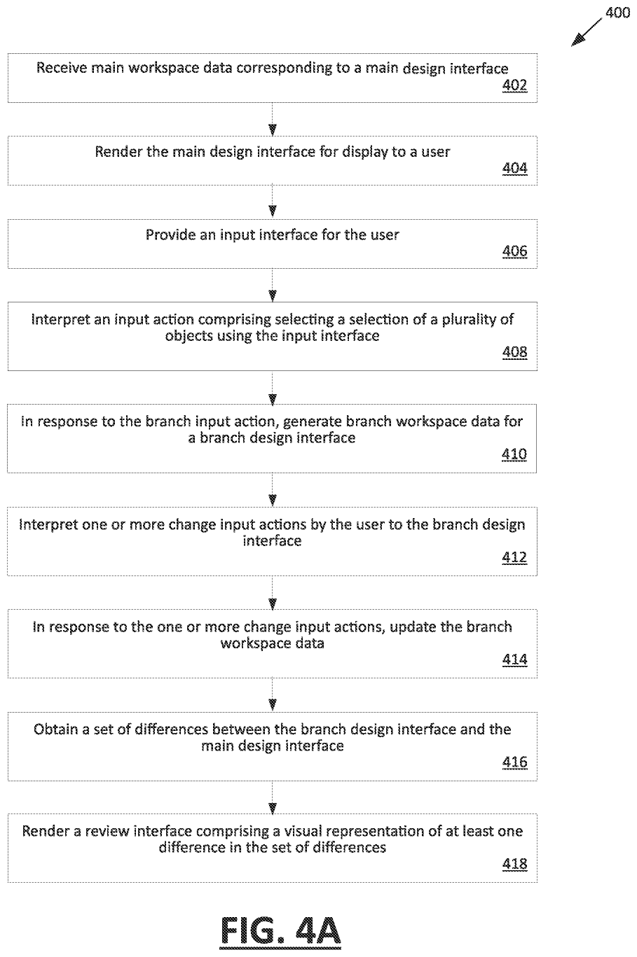

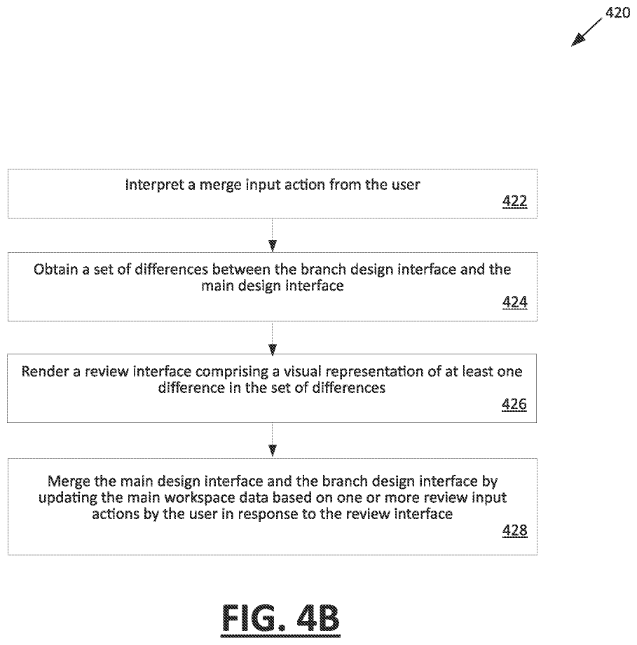

FIG. 4A illustrates a process for branching and merging in a design interface, according to one or more examples. Process 400 may be performed by one or more computing devices and/or processes thereof. For example, one or more blocks of process 400 may be performed by a user computing device (e.g., user computing devices 10-12, 600). In some examples, one or more blocks of process 400 are performed by a user computing device executing interactive graphic design system (IGDS) instructions provided by a network computer system (e.g., network computer system 150, 50).

At block 402, the user computing device receives main workspace data (e.g., main workspace data 128) describing a main design interface. The main design interface may include any layout of content and/or interactive elements, such as but not limited to a web page. In some examples, a network computer system storing workspace data in a workspace data store (e.g., workspace data store 164, 64) provides the workspace data to the user computing device.

At block 404, the user computing device renders the main design interface for display to a user. For example, the user computing device may render the main design interface on a canvas (e.g., canvas 122, 71-72). At block 406, the computing device provides an input interface (e.g., input interface 118) for the user. In some examples, the input interface 118 can be implemented as a functional layer that is integrated with a canvas to detect and interpret user input.

At block 408, the user computing device interprets a branch input action by the user to create a branch from the main design interface. At block 410, in response to the branch input action, the user computing device generates branch workspace data (e.g., branch workspace data 126) for a branch design interface based on the main workspace data. The branch workspace data describes a branch design interface created from the main design interface.

At block 412, the user computing device interprets one or more change input actions by the user to the branch design interface. The change input action/s include one or more modifications to the branch design interface, such as modifications made via the input interface. At block 414, in response to the one or more change input actions, the user computing device updates the branch workspace data.

At block 416, the user computing device obtains a set of differences between the branch design interface and the main design interface based on the main workspace data and the branch workspace data. For example, the user computing device may process the main workspace data and the branch workspace data to identify the set of differences. As an addition or alternative, the user computing device may request the set of differences from a network computer system (e.g., network computer system 150, 50) that processes the main workspace and the branch workspace data to identify the set of differences.

At block 418, the user computing device renders a review interface for display to the user comprising a visual representation of at least one difference in the set of differences. In some examples, blocks 416 and 418 are performed in response to input from a user of the user computing device, such as when the user initiates a review operation or merge operation.

FIG. 4B illustrates a process for branching and merging in a design interface resulting in a merge operation, according to one or more examples. Process 420 may be performed by one or more computing devices and/or processes thereof. For example, one or more blocks of process 420 may be performed by a user computing device (e.g., user computing devices 10-12, 600). In some examples, one or more blocks of process 420 are performed by a user computing device executing interactive graphic design system (IGDS) instructions provided by a network computer system (e.g., network computer system 150, 50).

At block 422, the user computing device interprets a merge input action by the user to create a branch from the main design interface. At block 424, in response to the merge input action, the user computing device obtains a set of differences between the branch design interface and the main design interface based on the main workspace data and the branch workspace data.

At block 426, in response to the merge input action, the user computing device renders a review interface for display to the user comprising a visual representation of at least one difference in the set of differences. At block 428, the user computing device merges the main design interface and the branch design interface by updating the main workspace data based on one or more review input actions by the user in response to the review interface.

### Network Computer System

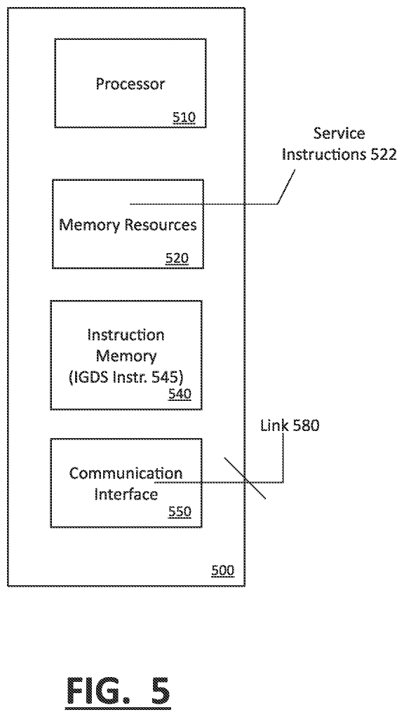

FIG. 5 illustrates a computer system on which one or more embodiments can be implemented. A computer system 500 can be implemented on, for example, a server or combination of servers. For example, the computer system 500 may be implemented as the network computing system 150 of FIG. 1A through FIG. 1C.

In one implementation, the computer system 500 includes processing resources 510, memory resources 520 (e.g., read-only memory (ROM) or random-access memory (RAM)), one or more instruction memory resources 540, and a communication interface 550. The computer system 500 includes at least one processor 510 for processing information stored with the memory resources 520, such as provided by a random-access memory (RAM) or other dynamic storage device, for storing information and instructions which are executable by the processor 510. The memory resources 520 may also be used to store temporary variables or other intermediate information during execution of instructions to be executed by the processor 510.

The communication interface 550 enables the computer system 500 to communicate with one or more user computing devices, over one or more networks (e.g., cellular network) through use of the network link 580 (wireless or a wire). Using the network link 580, the computer system 500 can communicate with one or more computing devices, specialized devices and modules, and/or one or more servers.

In examples, the processor 510 may execute service instructions 522, stored with the memory resources 520, in order to enable the network computing system to implement the network service 152 and operate as the network computing system 150 in examples such as described with FIG. 1A through FIG. 1C.

The computer system 500 may also include additional memory resources (“instruction memory 540”) for storing executable instruction sets (“IGDS instructions 545”) which are embedded with web pages and other web resources, to enable user computing devices to implement functionality such as described with the IGDS 100.

As such, examples described herein are related to the use of the computer system 500 for implementing the techniques described herein. According to an aspect, techniques are performed by the computer system 500 in response to the processor 510 executing one or more sequences of one or more instructions contained in the memory 520. Such instructions may be read into the memory 520 from another machine-readable medium. Execution of the sequences of instructions contained in the memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

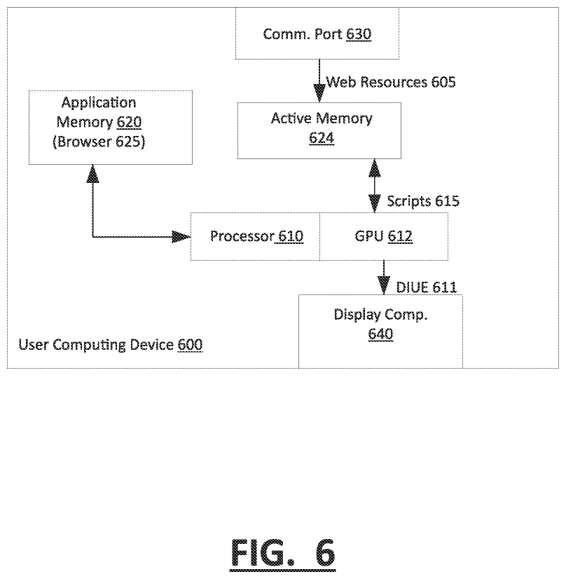

FIG. 6 illustrates a user computing device for use with one or more examples, as described. In examples, a user computing device 600 can correspond to, for example, a work station, a desktop computer, a laptop or other computer system having graphics processing capabilities that are suitable for enabling renderings of design interfaces and graphic design work. In variations, the user computing device 600 can correspond to a mobile computing device, such as a smartphone, tablet computer, laptop computer, VR or AR headset device, and the like.

In examples, the computing device 600 includes a central or main processor 610, a graphics processing unit 612, memory resources 620, and one or more communication ports 630. The computing device 600 can use the main processor 610 and the memory resources 620 to store and launch a browser 625 or other web-based application. A user can operate the browser 625 to access a network site of the network service 152, using the communication port 630, where one or more web pages or other resources 605 for the network service 152 (see FIG. 1A through FIG. 1C) can be downloaded. The web resources 605 can be stored in the active memory 624 (cache).

As described by various examples, the processor 610 can detect and execute scripts and other logic which are embedded in the web resource in order to implement the IGDS 100 (see FIG. 1A through FIG. 1C). In some of the examples, some of the scripts 615 which are embedded with the web resources 605 can include GPU accelerated logic that is executed directly by the GPU 612. The main processor 610 and the GPU can combine to render a design interface under edit (“DIUE 611”) on a display component 640. The rendered design interface can include web content from the browser 625, as well as design interface content and functional elements generated by scripts and other logic embedded with the web resource 605.By including scripts 615 that are directly executable on the GPU 612, the logic embedded with the web resource 615 can better execute the IGDS 100, as described with various examples.

### Conclusion

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computer system comprising:
a memory sub-system to store a set of instructions;
one or more memory resources storing interactive graphic design system instructions that, when executed by the one or more processors, cause the one or more processors to perform operations that comprise providing workspace data describing one or more design interfaces and the interactive graphic design system instructions to a user computing device, wherein the interactive graphic design system instructions, when executed at the user computing device, causes the user computing device to:
receive main workspace data describing a main design interface;
render the main design interface for display to a user at the user computing device;
provide an input interface for the user;
interpret a branch input action by the user to create a branch from the main design interface;
in response to the branch input action, obtain branch workspace data for a branch design interface generated based on the main workspace data;
interpret one or more change input actions by the user to the branch design interface;
in response to the one or more change input actions, update the branch workspace data;
obtain a set of differences between the branch design interface and the main design interface that are identified based on the main workspace data and the branch workspace data;
render a review interface for display to the user comprising a visual representation of at least one difference in the set of differences.

2. The network computer system of claim 1,
wherein obtaining the set of differences and rendering the visual representation is performed in response to a merge input action from the user;
wherein the interactive graphic design system instructions, when executed at the user computing device, cause the user computing device to: merge the main design interface and the branch design interface by updating the main workspace data based on one or more review input actions by the user in response to the review interface.

3. The network computer system of claim 1, wherein the visual representation of the at least one difference includes a side-by-side rendering of a portion of the main design interface and the corresponding portion of the branch design interface.

4. The network computer system of claim 1, wherein the visual representation of the at least one difference includes an overlay rendering of a portion of the main design interface and the branch design interface with a visual indicator of the corresponding difference.

5. The network computer system of claim 1, wherein the visual representation of the at least one difference includes, for a property of a component that is common to the main design interface and the branch design, a first visual representation of a first property value of the property in the main design interface and a second visual representation of a second property value of the property in the branch design interface.

6. The network computer system of claim 5, wherein the property is a color, style, shape, size, dimension, position, or font.

7. The network computer system of claim 1,
wherein the interactive graphic design system instructions, when executed at the user computing device, cause the user computing device to: provide change data to at least one of the main workspace data and the branch workspace data to the network computer system.

8. The network computer system of claim 1,
wherein the interactive graphic design system instructions, when executed at the user computing device, cause the user computing device to:
receive remote change data to at least one of the main workspace data and the branch workspace data generated at one or more other user computing devices;
update at least one of the main workspace data and the branch workspace data at the user computing device based on the remote change data.

9. A non-transitory computer-readable medium that stores instructions, executable by one or more processors, to cause the one or more processors to:
receive main workspace data describing a main design interface;
render the main design interface for display to a user at the user computing device;
provide an input interface for the user;
interpret a branch input action by the user to create a branch from the main design interface;
in response to the branch input action, obtain branch workspace data for a branch design interface generated based on the main workspace data;
interpret one or more change input actions by the user to the branch design interface;
in response to the one or more change input actions, update the branch workspace data;
obtain a set of differences between the branch design interface and the main design interface that are identified based on the main workspace data and the branch workspace data;
render a review interface for display to the user comprising a visual representation of at least one difference in the set of differences.

10. The non-transitory computer-readable medium of claim 9,
wherein obtaining the set of differences and rendering the visual representation is performed in response to a merge input action from the user;
wherein the instructions, when executed by the one or more processors, cause the one or more processors to: merge the main design interface and the branch design interface by updating the main workspace data based on one or more review input actions by the user in response to the review interface.

11. The non-transitory computer-readable medium of claim 9, wherein the visual representation of the at least one difference includes a side-by-side rendering of a portion of the main design interface and the corresponding portion of the branch design interface.

12. The non-transitory computer-readable medium of claim 9, wherein the visual representation of the at least one difference includes an overlay rendering of a portion of the main design interface and the branch design interface with a visual indicator of the corresponding difference.

13. The non-transitory computer-readable medium of claim 9, wherein the visual representation of the at least one difference includes, for a property of a component that is common to the main design interface and the branch design, a first visual representation of a first property value of the property in the main design interface and a second visual representation of a second property value of the property in the branch design interface.

14. The non-transitory computer-readable medium of claim 13, wherein the property is a color, style, shape, size, dimension, position, or font.

15. The non-transitory computer-readable medium of claim 9,
wherein the instructions, when executed by the one or more processors, cause the one or more processors to: provide change data to at least one of the main workspace data and the branch workspace data to the network computer system.

16. The non-transitory computer-readable medium of claim 9,
wherein the instructions, when executed by the one or more processors, cause the one or more processors to:
receive remote change data to at least one of the main workspace data and the branch workspace data generated at one or more other user computing devices;
update at least one of the main workspace data and the branch workspace data at the user computing device based on the remote change data.

17. A method for operating a computing device comprising one or more processors, the method comprising:
providing main workspace data describing a main design interface and interactive graphic design system instructions to a user computing device, wherein the interactive graphic design system instructions, when executed at the user computing device, causes the user computing device to:
receive main workspace data describing a main design interface;
render the main design interface for display to a user at the user computing device;
provide an input interface for the user;
interpret a branch input action by the user to create a branch from the main design interface;
in response to the branch input action, obtain branch workspace data for a branch design interface generated based on the main workspace data; interpret one or more change input actions by the user to the branch design interface;
in response to the one or more change input actions, update the branch workspace data;
obtain a set of differences between the branch design interface and the main design interface that are identified based on the main workspace data and the branch workspace data;
render a review interface for display to the user comprising a visual representation of at least one difference in the set of differences.

18. The method of claim 17, further comprising:
receiving change data from the user computing device describing changes to the branch design interface;
in response to receiving the change data, updating, in a workspace data store, branch workspace data corresponding to the branch design interface to reflect the change data.

19. The method of claim 17, further comprising:
receiving change data from the user computing device describing changes to the main design interface in a merge operation at the user computing device, updating, in a workspace data store, main workspace data corresponding to the branch design interface to reflect the change data.
